(19) United States
(12) Patent Application Publication
(10) Pub. No.: US 2025/0153222 A1
(43) Pub. Date: May 15, 2025

(54) Process for Redistributing Packages in a Sorting Station

(71) Applicant: Deutsche Post AG, Bonn (DE)

(72) Inventors: Frank Langer, Troisdorf (DE); Lukas Albert Schaffrinski, Neuss (DE)

(21) Appl. No.: 18/941,695

(22) Filed: Nov. 8, 2024

(30) Foreign Application Priority Data
Nov. 9, 2023 (DE) 10 2023 131 146.8

(51) Int. Cl. B07C 5/36; B07C 5/10

(52) U.S. Cl. CPC B07C 5/361; B07C 5/10; B07C 2501/0063

(57) ABSTRACT

A method for redistributing packages in a sorting station, in which the packages are delivered in a bundled manner in separate transport units to the sorting station, unloaded in the sorting station and transported successively to a scanning device in at least one transport sequence. The packages of the at least one transport sequence are scanned successively in accordance with the at least one transport sequence in order to detect respectively at least one size measurement and respectively at least one sorting parameter. The scanned packages are sorted in the at least one transport sequence in a sorting device on the basis of the at least one sorting parameter and divided into at least two parallel sorting sequences of packages. The packages of the parallel sorting sequences are successively loaded into different transport units by at least one robot in accordance with the sorting sequences and are transported away from the sorting station by the transport units. A control device determines at least two parallel, theoretical sorting sequences based on the at least one transport sequence and the at least one sorting parameter of the packages of the at least one transport sequence. The control device determines optimized sorting sequences to be loaded successively into the transport units in a space-saving manner based on the theoretical sorting sequences, based on the at least one size measurement of the packages of the theoretical sorting sequences and based on a loading algorithm. Only individual packages are removed from the transport sequence and/or from the sorting sequences and are reintroduced into the transport sequence and/or sorting sequences at another position in order to form the optimized sorting sequences determined by the control device. The packages are loaded into the transport units by the at least one robot in accordance with the optimized sorting sequences.

### CROSS-REFERENCE TO RELATED APPLICATION

This application claims priority to German Patent Application No. 10 2023 131 146.8 filed Nov. 9, 2023, the disclosure of which is hereby incorporated by reference in its entirety.

### BACKGROUND OF THE INVENTION

### Field of the Invention

The invention relates to a method for redistributing packages in a sorting station.

Methods for redistributing packages in sorting stations are known in various variants. In principle, in many of these methods, packages are fed to the sorting station bundled in transport units, which can be, for example, bodies of trucks or trailers. These transport units are then unloaded and transferred singulated to a conveyor belt. The packages can then be scanned, whereby a sorting parameter is recorded according to which the packages are sorted. Depending on the sorting parameter, the packages are then distributed to different transport units, with which the packages are then transported away from the sorting station. In many cases, these transport units, unlike the transport units that are unloaded in the sorting station, are roll containers, mesh boxes, pallets, pallets with walls or unit load devices (ULD). Unit load devices are pallets and containers that are used to load aircrafts and are therefore adapted to the dimensions of aircraft fuselages.

After scanning, the packages can be temporarily stored in a temporary storage, such as a rack storage system or similar, until they are transported onwards. The packages can then be removed from the temporary storage in a specific or any order. However, in order to achieve high efficiency and a short dwell time of the packages in the sorting station, temporary storage of the packages is often dispensed with. The packages are conveyed by conveyor belts or similar from the place of unloading from transport units to the place of loading into other transport units and sorted in the process. It is conceivable, for example, that some of the packages are moved from one conveyor belt to another conveyor belt or into a chute in order to sort the packages. If required, there is then a transport sequence in which the packages are transported, scanned and fed to a sorting device. After the sorting, the packages form at least two sorting sequences. Each sorting sequence typically contains packages with a different sorting parameter. Each sorting sequence is fed to different transport units, into which the packages are placed by a robot as required.

### Description of Related Art

In order to make efficient use of the space available in the transport units, the dimensions of the packages are also recorded in some cases. A loading algorithm can then specify where certain packages should be stacked in the transport units in order to waste as little space as possible. Supportingly, sensors can also be used to monitor the current loading situation of the transport units. If the packages are temporarily stored in the sorting station, the packages can be removed from the temporary storage in a sequence in which they can be stacked in a space saving manner.

Loading transport units with sorted packages in sorting stations with the help of robots does not achieve satisfactory efficiency despite the technical aids. In many cases, manual loading is faster and more accurate. However, manual loading does not allow automation. In other cases, a lot of space is wasted in the transport units despite the high technical effort involved in loading.

### SUMMARY OF THE INVENTION

Therefore, the present invention is based on the object of providing and further developing the method of the type mentioned at the beginning and explained in more detail above in such a way that the efficiency of sorting stations can be further increased at a reasonable expense.

This object is solved as described herein by a method for redistributing packages in a sorting station,
in which the packages are delivered in a bundled manner in separate transport units to the sorting station, unloaded in the sorting station and transported successively to a scanning device in at least one transport sequence,
in which the packages of the at least one transport sequence are scanned successively in accordance with the at least one transport sequence in order to detect respectively at least one size measurement and respectively at least one sorting parameter,
in which the scanned packages are sorted in the at least one transport sequence in a sorting device on the basis of the at least one sorting parameter and divided into at least two parallel sorting sequences of packages,
in which the packages of the parallel sorting sequences are successively loaded into different transport units by at least one robot in accordance with the sorting sequences and are transported away from the sorting station by the transport units,
in which a control device determines at least two parallel, theoretical sorting sequences based on the at least one transport sequence and the at least one sorting parameter of the packages of the at least one transport sequence,
in which the control device determines optimized sorting sequences to be loaded successively into the transport units in a space-saving manner based on the theoretical sorting sequences, based on the at least one size measurement of the packages of the theoretical sorting sequences and based on a loading algorithm,
in which only individual packages are removed from the transport sequence and/or from the sorting sequences and are reintroduced into the transport sequence and/or sorting sequences at another position in order to form the optimized sorting sequences determined by the control device, and
in which the packages are loaded into the transport units by the at least one robot in accordance with the optimized sorting sequences.

According to the method, during the distribution of the packages between the unloading from the transport units and sorting in the sorting device, the packages are transported successively in the form of a transport sequence, from which at least two sorting sequences are generated as a result of the sorting of the packages in the sorting device. Each of the sorting sequences is intended for loading in the corresponding sequence into different transport units by a robot. Temporary storage of the packages is dispensed with in order to avoid the associated logical and equipment-related effort. However, individual packages are removed from the transport sequence or at least one sorting sequence in order to reinsert them into the transport sequence or at least one sorting sequence at a different position, typically but not necessarily further upstream, in order to change the transport sequence or at least one sorting sequence in such a way that the robot can load the packages into the transport units in the then changed sequence to save space. The robot is then preferably not only fed a sequence of packages that can be loaded in a more space-saving manner than the sequence of packages that has not been changed, but also specified by a control device where the respective packages are to be placed in the transport units so that as high a packaging density as possible of the packages in the transport units can be achieved. As a result, the efficiency of both the sorting station and the process for redistributing packages in a sorting station can be increased without requiring disproportionate effort.

The packages are delivered to the sorting station bundled in separate transport units, which may, for example, be truck bodies or trailers. The packages are typically stacked therein and thereby form a bundle of packages in which the packages are not in any particular sequence. The transport units are then unloaded in the sorting station, wherein several transport units being unloaded successively one after the other. However, this does not rule out the possibility of unloading separate transport units in parallel. During unloading, the packages are singulated and guided past a scanning device, for example by at least one conveyor belt, one after the other in at least one transport sequence. The packages transported to the scanning device in the at least one transport unit are scanned, wherein, respectively, at least one size measure and one sorting parameter of the packages is determined.

The subsequent sorting of the packages takes place on the basis of this at least one sorting parameter. The sorting parameter can, for example, contain a destination information as to where the respective package is to be transported, such as a zip code or similar. Packages with the same sorting parameters do not necessarily have to be grouped together during sorting. Packages with sorting parameters that lie within a predefined range of values, for instance in the sense of postal code ranges, can also be grouped together. By the sorting of the packages in the sorting device, the transport sequence of the packages is divided into at least two separate sorting sequences of packages. Depending on the number of criteria used for sorting, more or less separate sorting sequences are produced during sorting.

The packages of the different sorting sequences are loaded into different transport units without being mixed together again. The packages of each sorting sequence are loaded successively one after the other according to the respective sequence. The robot therefore loads the packages one after the other in the order in which the packages are transported to the robot according to the sorting sequence. It is particularly useful, but not absolutely necessary, if each sorting sequence of packages is loaded into separate transport units by a separate robot. The loaded transport units are transported away from the sorting station. If the sorting sequence still contains further unloaded packages, the next transport unit is loaded with the remaining packages and so on.

The process for redistributing packages in the sorting station is controlled by a control device that has access to the information collected by the scanning device. The control device therefore knows the arrangement of the package in the transport sequence of packages for each package in the scanned transport sequence of packages. It is therefore known which packages are provided before and after a particular package in the transport direction. In addition, the control device knows the at least one size measure and the at least one sorting parameter for each package. Using this data, the control device determines the theoretical sorting sequences that will result when the packages have been sorted by the sorting device. In the event that the sequence of the packages is not changed after scanning and before sorting, the theoretical sorting sequences should correspond to the actual sorting sequences.

The control device uses the theoretical sorting sequences, the associated dimensions of the packages and a loading algorithm to determine modified sorting sequences that can be loaded into the transport units one after the other in a more space-saving manner than the unmodified sorting sequences. The modified sorting sequences are therefore optimized sorting sequences that are optimized for space-saving loading. The optimized sorting sequences do not have to be an absolute optimum, but merely an improvement on the unchanged sorting sequence. The term “optimize” should generally be understood in a general sense.

It is conceivable, for example, that two very large packages follow each other in a theoretical sorting sequence and that a considerable amount of free, unused space remains in the transport unit when they are loaded one after the other. It may then make sense to move one of the packages further upstream in the sorting sequence. It may then be possible to arrange further small packages after the first large package in the gaps in the transport unit before the other large package is loaded. The question of whether packages can be loaded in a space-saving manner depends on the previously loaded packages and the resulting current loading situation, which can be calculated at least approximately in advance by the control unit. It is also conceivable that a large package should no longer be loaded into an almost full transport unit, but first into a transport unit that is still unloaded. The large package can then be moved to the back of the optimized sorting sequence accordingly.

There are various process options for optimizing the sorting sequences according to the method. What these options have in common is that certain packages are removed from a sequence of packages and reintroduced into the sequence of packages at another position, which changes the sequence of packages without all packages having to be temporarily stored in a buffer. This means that only individual packages are ejected from a series of packages and not all packages. Since the control device can already deduce the theoretical sorting sequence from the transport sequence after scanning the packages, individual packages can be removed from the respective sequence, i.e. the transport sequence and/or the sorting sequence, before and/or after sorting. The packages can then be fed into the transport sequence or the sorting sequence regardless of the sequence from which they were removed. For the sake of simplicity, however, it is advisable for the packages removed from the transport direction to be reintroduced into the transport sequence and for a package removed from a sorting sequence to be reintroduced into this sorting sequence at a different location.

In principle, it makes sense to remove packages from a sequence and to stop briefly at the point of removal until the removed package has been passed by the package behind which the package is to be reintroduced into the sequence. In this case, there is no need to transport the removed package to any significant extent before it is reintroduced. However, the removed package can also be transported against or with the transport direction of the packages before it is reintroduced into the sequence. This then allows packages to be moved very quickly to a position significantly further upstream in the sequence or very quickly to a position further forward in the sequence, which can significantly increase the flexibility and therefore the efficiency of the process.

When the transport sequence of the packages is changed to an optimized transport sequence, the control device has preferably already taken into account when determining the optimized transport sequence that the optimized transport device will subsequently be sorted and according to which criteria this sorting will take place. It is then clear which specific, optimized sorting sequences will occur after the optimized transport sequence has been sorted. Ultimately, regardless of the point at which the sequence of packages is changed and thus optimized, an optimized and not merely random sorting sequence of packages is provided in front of the at least one robot that performs the loading. The packages are thus loaded into the transport units by the at least one robot in accordance with the optimized sorting sequences.

Packages can generally be understood to mean unit loads of different types. However, unit loads of a particular type can also be meant, such as goods packed in packaging. Packages can therefore have at least one outer packaging made of paper, cardboard, fabric or plastic and can be in the form of parcels, boxes and containers, for example, as well as non-stable containers such as bags or pouches. The goods packed in packages can themselves be individual piece goods, bulk goods, liquids or pasty materials.

In a first, particularly preferred embodiment of the method, the packages are scanned in at least one preliminary transport sequence. This is a preliminary transport sequence because this transport sequence is changed before the transport sequence is sorted in order to save space during loading. To this end, certain packages, i.e. only individual packages, are removed from the transport sequence and reintroduced into the transport sequence at another point. In this way, an optimized transport sequence determined by the control device is generated under the specification of the control device. The packages in the optimized transport sequence are then sorted in the sorting device into at least two, preferably optimized, sorting sequences using the at least one sorting parameter. The packages can then be loaded into the transport units in the respective, optimized sorting sequence in a very space-saving manner using the at least one robot. A suitable sequence of packages is fed to the robot, whereby the robot can place the packages one after the other at suitable locations into the transport units. The corresponding positions can be specified to the robot by the control device. Depending on the loading situation and the package, the packages can be placed next to each other and/or on top of each other in the transport unit.

Alternatively, the packages in the transport sequence can be sorted in at least one preliminary transport sequence, in particular in the preliminary transport sequence in which the packages have been scanned, into at least two preliminary sorting sequences in a sorting device using the at least one sorting parameter. Only after the packages have been sorted into two separate preliminary sorting sequences are individual, but not all, packages removed from these and reintroduced at a different position in the sorting sequence. In this way, optimized sorting devices determined by the control device are formed, which can be loaded into the transport units easily and in a space-saving manner using the at least one robot. These are therefore preliminary sorting sequences, because these sorting sequences are converted from a preliminary sorting sequence into an optimized sorting sequence before the packages are loaded. An absolute optimum in space saving will not necessarily be achieved even with the optimized sorting sequence. However, the robot can load the optimized sorting sequence into the transport units in a more space-saving manner than the preliminary sorting sequence. This applies in any case after the calculation by the control device on the basis of a loading algorithm or similar.

It is also conceivable that the transport sequence of the packages is changed and then at least one of the sorting sequences is also changed after sorting. In many cases, however, this will not be preferable due to the additional effort involved.

In order to be able to optimize the sorting sequence in a suitable manner and not only have to rely on the calculations of the control device, it is advisable if the current loading status of at least one transport unit for loading the packages is monitored during the loading of the packages by means of at least one, in particular optical, sensor. The sorting sequence can then always be optimized taking into account the actual and not just the calculated loading state of the transport unit. It is then irrelevant whether the transport sequence and/or at least one sorting sequence is changed for this purpose.

In principle, it can be useful if the at least one size parameter is scanned using a six-sided scanner, a volume scanner and/or a line scanner, in particular an RGB line scanner. The six-sided scanner scans the packages from all six spatial directions so that the actual size dimensions can be recorded very accurately. The more precisely the dimensions are known, the more effectively the sorting sequences can be optimized. In principle, scanners of the types mentioned are known from similar applications.

A six-sided scanner can preferably take an image of all six sides of the package, whereby the pixels of the images can then be evaluated. For example, the pixels belonging to a package can be counted and the size dimensions of the package can be determined from this, especially if a calibration has previously been carried out with regard to the ratio of pixel numbers and size dimensions. In a simpler case, a line scanner can also be used, past which the packages are transported. The line scanner scans one side of the package, for example from above, and captures images line by line. The pixels of each line can then be plotted against time or the number of lines in succession, resulting in images from a large number of individual lines and thus ultimately pixel areas that correlate with the size dimensions of the packages. After a corresponding calibration, the pixel area can be assigned to the size of the package from the corresponding viewing direction. RGB scanners are particularly preferred in this context, whereby RGB refers to a color space that is formed using the colors red, green and blue, i.e. the primary colors of light. Put simply, the line scanner captures the colors red, green and blue. In contrast to line scanners, six-sided scanners allow the volume or three-dimensional shape of the package to be determined. However, volume scanners, which usually use lasers, can also be used as an alternative or in addition. The volume scanners can also be designed as line scanners, which the packages are then transported past. The advantage of these scanners is that the three-dimensional shape of the packages can be deduced from a point cloud of the laser captured by a corresponding detector. Typically, the side of a package lying on a conveyor belt is not scanned, but this can regularly be accepted. In most cases, the packages are exposed to the laser from one side, in particular at least essentially from above.

When using a six-sided scanner, a volume scanner, a line scanner, in particular an RGB line scanner, and/or other suitable scanning devices, it is advisable to scan at least two, in particular at least three, size parameters of each package. These can be the height, width and/or length of the packages. In some cases, it may also be preferable to specifically record the maximum height, the maximum width and/or the maximum length of the packages. If the dimensions are known in multiple dimensions, the control device can more reliably calculate an actual space-saving loading. This leads to better optimized sorting sequences of the packages for loading into the transport units, which is especially true if the packages can have very different dimensions.

In addition to the scanning size measures in the form of pure dimensions, it may also be possible to scan the shape and/or surface of the packages. This is particularly useful if the packages are not or not always cuboid or very thin or very flexible. In the case of packages that are not cuboid, a different relative arrangement to each other can be more space-saving than with cuboid packages of approximately the same size. If the shape and/or the surface of the packages is known to the control device, the control device can use the scanned shape and/or the surface of the packages to determine whether the shape is at least one predetermined special shape of the packages.

The control device can specify the handling of the special shapes according to other criteria than just the size dimensions and sorting parameters. A surface is preferably scanned by capturing an image of at least one surface. For example, at least one image from a six-sided scanner or at least one image of the surface composed line by line by a line scanner can be used here. An evaluation of the surface can then be carried out using the color gradients or gray value distributions, for example.

For example, it is possible to specify that certain special shapes are removed from the sequence of packages. The special shapes can then be removed from the, in particular preliminary, transport sequence and/or from the, in particular preliminary, sorting sequence. Removal after the sorting device requires a longer transportation in the sorting station. However, the special shape has then been sorted according to the at least one sorting parameter, which can be useful for further handling of the packages. The packages with the special shapes can be loaded into different transport units compared to the packages that do not have the at least one special shape. These may be separate transport units that are only intended for loading special shapes. Alternatively or additionally, the special shapes can be provided for manual loading. Loading into transport units is then not carried out by a robot. In this context, such shapes may be considered as special shapes which cannot be handled or loaded by a robot or can only be handled or loaded with difficulty by a robot. Consequently, the at least one robot present is not blocked by such packages with special shapes. Packages with special shapes do not even reach the robot and are loaded manually elsewhere.

In principle, it can be appropriate to load packages with special shapes in transport units together with packages that do not have special shapes. In the case of certain special shapes, however, it may be appropriate to load only special shapes in separate transport units, which may but does not need to signify that only packages that do not have a special shape are loaded in other transport units. For example, it may also be specified that the packages with a certain special shape are loaded into the transport units in a certain orientation. It is also conceivable that individual special shapes are loaded with other special shapes adjacent to each other in a predetermined orientation to save space.

By scanning the shape and/or surface of the packages, very thin packages can be recognized, for example, those with a height of between 0.3 cm and 1 cm. Such packages are then more likely not to be parcels, for example, but rather envelopes, which are preferably loaded into the transport unit in an upper area of the transport unit if required. This can have an influence on the preferred sorting sequence. If necessary, the shape of the scanned sides of the packages can also be used to determine whether the packages are more rigid or more flexible. Packages without straight edges and/or which do not have sharp corners can, for example, be regarded as bags or pouches. Also in the case of bags or pouches, it may be desirable to load them at the top of the transport unit to avoid damaging these packages. If many light reflections are recognized as zonal light-dark contrasts when scanning the surface, it can also be concluded that the package is a bag, a pouch or a paper package. As such packages are also rather sensitive to mechanical impacts, it is also a advisable for the packages to be loaded at the top of a transport unit. It may also be advisable to sort the aforementioned, more easily damaged packages in a separate sorting sequence in order to sort them separately from other types of packages in separate transport units. Very thin and/or flexible packages can also be recognized as such by “machine learning”, whereby the scanner is trained by real packages to automatically recognize similar ones. For example, it is then possible to automatically and very reliably distinguish between bags, parcels and envelopes, each of which is then handled in a different, preferred way or loaded separately into other transport units.

If the shape and/or surface of the packages or the type of packages is known to the control device, the control device can decide whether the respective packages can be handled by the robot. For this purpose, the control device can compare the shape and/or surface of the packages with the shapes stored in the control device as being able to be handled by at least one robot. If the shapes and/or surfaces of the packages can probably not be handled by a robot, the packages can, for example, be sorted out in order to be loaded by hand or the like.

In order to waste as little space as possible in the transport units, it may be advisable for the control device to generate electronic 3D models of the packages from the scanned shape and/or surface of the packages. This is particularly the case if the shapes of the packages are very different in many cases and are not cuboid or similar. The control device can then also use the electronic 3D models of the packages to determine space-saving, optimized sorting sequences to be loaded one after the other into the transport units. The loading algorithm can then take the respective 3D shape into account very realistically and precisely in order to determine an optimized sorting sequence.

Alternatively or additionally, the control device can use the scanned shape and/or surface of the packages to infer article classes of the packages, which have previously been defined accordingly depending on the shape and/or surface. The shape and/or surface of packages can often be used to decide what type of packages they are and what properties characterize them. For example, bags, envelopes and pouches usually have characteristic shapes and/or surfaces and are also characterized by the fact that they are quite flexible, which can have an influence on where and together with which other packages these packages can be conveniently loaded into transport units. The recognition of certain article types can be further improved if the weight of the packages is also determined, for example during the scanning of the packages, immediately before or immediately after. Certain article classes can also be intended to be loaded at the very top of the transport units or manually into separate transport units so that the packages are not damaged by the weight of other packages. The control device therefore also determines space-saving, optimized sorting sequences to be loaded one after the other into the transport units based on the article classes of the packages.

The weight of certain packages, preferably each package, can be determined independently of or in addition to the determination of the shape and/or the surface. It is then possible, for example, to draw conclusions about the type of package or to avoid loading particularly heavy packages at the top of the transport units or on small, light packages so as not to crush or otherwise damage the packages below. The control device can therefore also use the weight of the packages to determine space-saving, optimized sorting sequences to be loaded one after the other into the transport units.

If the size measures and/or sorting parameters of at least individual packages are communicated to the control device before the transport unit is unloaded, the control device can already start to calculate different loading situations in order to be able to determine optimized sorting sequences of the corresponding packages still to be sorted as quickly as possible, which can only be finally done when the actual, preliminary transport sequence of the unloaded packages is known, whereby at least one size measure and at least one sorting parameter is then assigned to each package. Before the packages are unloaded, for example, the size measures and sorting parameters associated with the packages are already known. When the packages have already been scanned for these properties during or before loading. Then, for example, the control device already knows which packages will be delivered with the transport unit, preferably before the packages are delivered to a transport unit. It can be particularly useful, in order to determine the fastest and most optimal sorting sequences of the packages, if
the size measures and/or sorting parameters of the at least individual packages communicated before scanning are matched with the scanned size measures and/or sorting parameters of at least individual packages. The packages, which are in principle known in advance, are then recognized, so to speak, and it can be assumed which packages will be unloaded in which order. The preliminary transport sequence of the unloaded packages is then presumably composed accordingly.

Under certain circumstances, it can be useful if the control device determines, based on the transmitted size dimensions and/or sorting parameters of at least individual packages, an optimized sorting sequence for the at least individual packages, in particular before the at least individual packages are unloaded. It can be determined whether this can be further optimized and/or how this optimized sorting sequence can be generated as quickly and easily as possible. The control device can then determine the optimized sorting sequence of the packages after the packages have been scanned, taking into account the optimized sorting sequences theoretically determined before the packages were scanned using the communicated size dimensions and/or sorting parameters.

The advantages of the method described can be utilized in a particularly practical manner if the packages are unloaded from transport units in the form of commercial vehicle bodies, preferably box bodies, in particular a truck, trailer or semi-trailer. Alternatively or additionally, it may also be possible for the packages to be unloaded from transport units in the form of non-self-propelled low-floor vehicles, in particular in the form of trolleys, pallet cages or unit load devices (ULD). In such processes, many large packages are distributed in a very short time, which is why optimizing the space in the transport units is both desirable and difficult.

Alternatively or additionally, for the same reasons, it is preferable if the packages are loaded into non-self-propelled low-floor vehicles, in particular in the form of trolleys, pallet cages or unit load devices (ULD). Unit load devices are pallets and containers that are used to load aircrafts and are therefore adapted to the dimensions of aircraft fuselages.

With regard to the packages, the method described is suitable if the packages are packaged piece goods, in particular piece goods wrapped in a cardboard box. It is particularly useful if the unit loads are parcels, bags, envelopes and/or pouches. These packages are to be sorted and distributed in sorting systems in large numbers and with a short dwell time.

### BRIEF DESCRIPTION OF THE DRAWINGS

The invention is explained in more detail below with the aid of a drawing only showing an embodiment. In the drawing shows

FIG. 1 a top view of a sorting station for redistributing packages according to the invention, and

FIG. 2: the loading of packages in an optimized sorting sequence with a robot of the sorting station from FIG. 1 in a side view.

### DESCRIPTION OF THE INVENTION

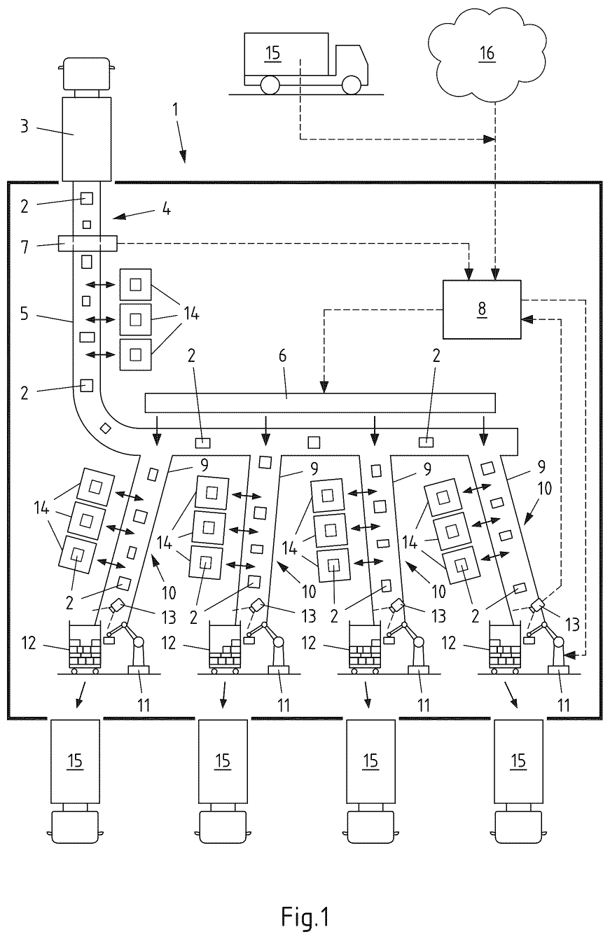

FIG. 1 shows a sorting station 1 for redistributing packages 2. The packages 2 can be piece goods, parcels, envelopes, bags and/or sacks. The packages 2 are transported to the sorting station 1 by transport units 3 in the form of utility vehicles, in particular trucks, trailers and/or semi-trailers, whereby the packages 2 are located in the structures of the utility vehicles. Once at the arrived sorting station 1, the packages 2 are unloaded and singulated. In the preferred method shown, a single transport sequence 4 of packages 2 is generated from the unloaded packages 2. The transport sequence 4 is transported, in particular at least substantially continuously, by at least one conveyor belt 5 through the sorting station 1 to a sorting device 6. If necessary, several transport sequences 4 can also be generated, which can then be handled in parallel in the sorting station 1.

The transport sequence 4 of the packages 2 is fed to a scanning device 7, in which a sorting parameter, in particular a zip code, and size measures are recorded for each package 2. The weight of the packages 2 is also recorded. However, this is optional. Whether it makes sense to record the weight depends on the type of packages 2 and on how the packages 2 differ in terms of their weight. In the method shown and insofar preferred, the packages 2 are transported through a six-sided scanner of the scanning device 7, whereby the packages 2 are scanned from all six sides. Target information such as a zip code is thereby read out, which is relevant as a sorting parameter for the subsequent sorting of the packages 2. The size dimensions length, height and width as well as the shape of the packages 2 are also recorded. In addition, the weight of the packages 2 is determined as they pass through the scanning device 7, if this appears appropriate.

The sequence of the packages 2, the sorting parameters assigned to the packages 2, the size dimensions, the shapes and weights are transmitted to a control device 8. The packages 2 are transported from the scanning device 7 to the sorting device 6, where the packages 2 are distributed to different conveyor belts 9 according to the sorting parameter. This takes place controlled by the control device 8 using the transport sequence 4 of the packages 2 and the sorting parameters assigned to the packages 2. For sorting the packages 2, they can first be transferred to rockers according to the transport sequence 4, which transport the packages 2 past the other conveyor belts 9 and tilt the packages 2 onto the conveyor belts 9 assigned to the sorting parameters according to the sorting parameters. Alternatively, the packages 2 can also be actively moved from the sorting device 6 to the conveyor belts 9 assigned to the sorting parameter. Other types of sorting are also possible and known. On the conveyor belts 9 adjoining the sorting device 6, sorting sequences 10 of the packages 2 are formed, which result from the transport sequence 4 of the packages 2 upstream of the sorting device 6 and the assignment of the sorting parameters to the packages 2 of the transport sequence 4.

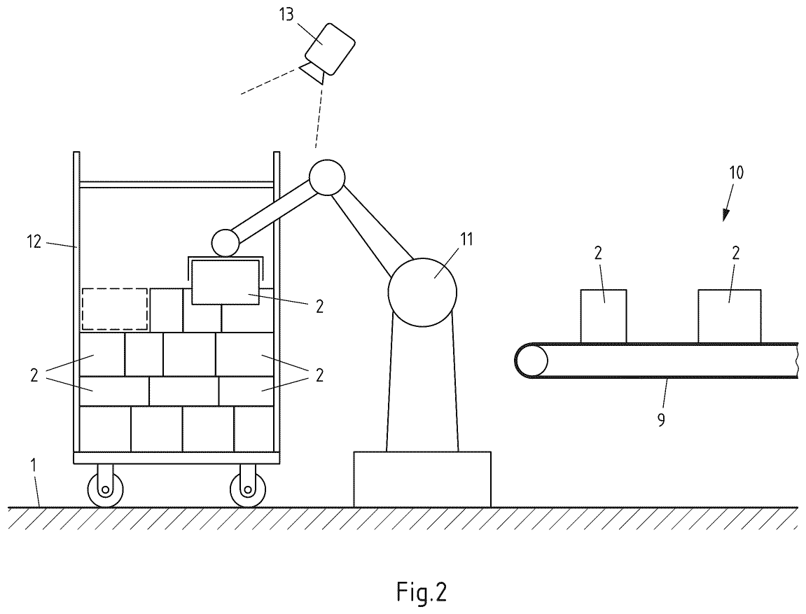

As shown in FIG. 2, the sorting sequences 10 of the packages 2 are loaded according to their order by robots 11 into transport units 12 in the form of trolleys, which in turn can then be loaded into structures of commercial vehicles such as trucks, trailers or semi-trailers. The control device 8 instructs the robots 11 where to place the packages 2 in the transport units 12 in order to make good use of the loading capacity of the transport units 12. This is shown schematically by the gap in the transport unit 12 highlighted by a dashed line for inserting the next package 2. Unused spaces in the transport units 12 between the packages 2 should be avoided or reduced as far as possible. The transport units 12 are each assigned sensors 13, in particular optical sensors, which detect the current loading situation and transmit this to the control device 8. If necessary, the sensors 13 can also only forward images of the transport units 12, from which the control device 8 then determines the current loading situation.

For this purpose, it is not only helpful to load the packages 2 one after the other at a suitable position in the transport units 12, but also to influence the sequence of the packages 2 in such a way that, if possible, the subsequent packages 2 are selected taking into account the already loaded packages 2, i.e. depending on the respective loading situation, in such a way that space-saving loading is possible for each package 2. Whether a package 2 can be loaded in a space-saving manner depends not only on the package 2 itself, but also on the space available in the transport unit 12 for loading the package 2. A package 2 can be loaded in a spatially exact manner in certain loading situations. In other loading situations, however, the same package 2 may only be loaded in such a way that a lot of space in the transport unit 12 remains unused.

The sorting sequences 10 of the packages 2 are therefore changed in such a way that the packages 2 can be loaded in the sorting sequence 10 in a more space-saving manner than without changing the sorting sequences 10. The deliberately changed sorting sequences 10 are also referred to as optimized sorting sequences 10, the changing of the sorting sequences 10 can be done in different ways. It would be desirable to achieve an absolute optimum with regard to the sorting sequence 10. However, this is not necessary and in many cases can hardly be achieved with reasonable effort.

The sorting sequences 10 can be changed by removing individual packages 2 from the resulting preliminary sorting sequence 10 after the packages 2 have been sorted and then reintroducing them into the sorting sequence 10 at another point. In addition to the sorting sequences 10 conveyed on conveyor belts 9 to the robots 11, the illustrated and thus preferred sorting station 1 has pick-up stations 14 for temporarily receiving packages 2. Certain packages 2 can be moved to the pick-up locations 14 and thus removed from the preliminary sorting sequence 10. From the pick-up locations 14, the packages 2 can be fed back into gaps in the sorting sequence 10, thus forming an optimized sorting sequence 10. Appropriate sliders, not shown but otherwise known, can be provided for removing and inserting the packages 2. The removal and insertion of the packages 2, for example the actuation of the corresponding pushers, is controlled by the control device 8.

An alternative or additional procedure is that packages 2 are already removed from the preliminary transport sequence 4 and are reintroduced into the transport sequence 4 at another point to form an optimized transport sequence 4 and thus to form optimized sorting devices 10. As previously described in connection with the sorting sequences 10, removal can take place from pick-up locations 14, where the removed packages 2 remain until they are reintroduced into a gap in the transport sequence 4. This removal and insertion is also controlled by the control device 8. It is aware of the sorting parameters according to which the packages 2 are sorted and which sorting parameters the packages 2 have. This means that changing the transport sequence 4 can have a targeted effect on optimizing the sorting sequences 10.

It is not shown, but conceivable, that the removed packages 2 do not remain at the location of removal from the transport sequence 4 and/or sorting sequence 10 until the packages 2 are returned to the corresponding transport sequence 4 and/or sorting sequence 10. The packages 2 could also be moved with or against the respective conveying direction of the packages 2 that have not been removed in order to insert the packages 2 further downstream in the transport sequence 4 and/or sorting sequence 10 or much further backstream in a short time.

In accordance with the information communicated by the scanning device 7, the control device 8 uses a predefined loading algorithm to determine a modified sorting sequence 10, which is recognized as preferred for loading in the transport units 12. The control device 8 simultaneously specifies which packages 2 are to be removed at which point and which removed packages 2 are to be reintroduced at which point in order to generate the modified, optimized sorting sequences 10. By the corresponding removal and insertion of individual packages 2, the predetermined optimized sorting sequences 10 estimated as appropriate by the control device 8 are then created.

The control device 8 can thereby first generate 3D models of the scanned packages 2 in order to then determine the exact space requirement of the packages 2 in the loading algorithm. This is particularly useful for irregularly shaped packages 2. The shape of the packages 2, which can be detected by the scanning device 7 and/or determined by the control device 8, can be used to draw conclusions about certain article classes of the packages 2. In addition to the dimensions, such article classes can also influence where the packages 2 are loaded in the transport units 12 and where the packages 2 are arranged for this purpose in the sorting sequences 10. The article type can also influence the sorting of the packages 2 in the sorting device 6. For example, certain article types can be sorted in separate sorting sequences 10, even if they have the same sorting parameter. Certain article types, for example particularly fragile packages 2, can then be loaded into separate transport units 12, manually if necessary.

The control device 8 can also assign certain packages 2 to certain special shapes based on the size dimensions of the packages 2 and provide special handling for the special shapes of the packages 2. The special shapes can be sorted into separate sorting sequences 10, even if they have the same sorting parameters as packages 2 not assigned to the special shapes. Packages 2 with certain special shapes can then be loaded together more easily and in a space-saving manner in a common transport unit 12, while packages 2 without special shapes are in turn loaded together in a transport unit 12. However, special shapes can also mean that the packages 2 should be loaded in certain orientations and/or at certain points in the transport units 12. Even then, the sorting sequences 10 may have to be changed accordingly to enable this loading.

The control unit 8 can also take the weight of the packages 2 into account when specifying the optimized sorting sequences 10. It may be appropriate, for example, if particularly heavy and at the same time quite small packages 2 are loaded at the bottom of the transport unit 12. These packages 2 must therefore be arranged in the sorting sequence 10 in such a way that they are in line for loading when the transport unit 12 is still quite empty. However, the control device 8 can also provide for particularly heavy packages 2 to be sorted out at a different position in the sorting device 6 than the less heavy packages 2 with the same sorting parameters. These can then be loaded separately into separate transport units 12, where they cannot damage the lighter packages 2 loaded into other transport units 12. However, the heavy packages 2 to be loaded separately can in turn be arranged in an optimized sorting sequence 10 on the basis of their dimensions, using the measures already described above.

It is also conceivable that the packages 2 of the bodies of the utility vehicles 15 to be unloaded in the sorting station 1 have already been scanned before being loaded into the bodies. In this case, their dimensions, weights, shapes and/or sorting parameters are known. It may also be known approximately where the packages 2 have been loaded into the bodies, so that it is possible to estimate when the packages 2 will be unloaded again in the sorting station 1. This information can be communicated to the control device 8 before the corresponding packages 2 are unloaded. The information can be sent directly from the loading location, an intermediate server or a central unit 16. The corresponding utility vehicle 15 can then also inform the control device 8, for example while en route, when it is estimated to arrive at the sorting station 1. If necessary, the commercial vehicle 15 can also transmit information about the loaded packages 2.

If the control device 8 receives information about the packages 2 that are soon to be sorted, the control device 8 can use a predefined loading algorithm to estimate which optimized sorting sequences 10 promise good space utilization in the transport units 12 and are easy to provide. After scanning the packages 2 in the scanning device 7, the estimates regarding the sequences of the packages 2 can then be compared with the actual transport sequence 4. Further adjustments can then be made to the calculation of the optimized sorting sequences 10.

### LIST OF REFERENCE SYMBOLS

1 sorting station
2 package
3 transport unit
4 transport sequence
5 conveyor belt
6 sorting device
7 scanning device
8 control unit
9 conveyor belt
10 sorting sequence
11 robot
12 transport unit
13 sensor
14 pick-up location
15 utility vehicle
16 central unit

1. A method for redistributing packages in a sorting station,
in which the packages are delivered in a bundled manner in separate transport units to the sorting station, unloaded in the sorting station and transported successively to a scanning device in at least one transport sequence,
in which the packages of the at least one transport sequence are scanned successively in accordance with the at least one transport sequence in order to detect respectively at least one size measurement and respectively at least one sorting parameter,
in which the scanned packages are sorted in the at least one transport sequence in a sorting device on the basis of the at least one sorting parameter and divided into at least two parallel sorting sequences of packages,
in which the packages of the parallel sorting sequences are successively loaded into different transport units by at least one robot in accordance with the sorting sequences and are transported away from the sorting station by the transport units,
in which a control device determines at least two parallel, theoretical sorting sequences based on the at least one transport sequence and the at least one sorting parameter of the packages of the at least one transport sequence,
in which the control device determines optimized sorting sequences to be loaded successively into the transport units in a space-saving manner based on the theoretical sorting sequences, based on the at least one size measurement of the packages of the theoretical sorting sequences and based on a loading algorithm,
in which only individual packages are removed from the transport sequence and/or from the sorting sequences and are reintroduced into the transport sequence and/or sorting sequences at another position in order to form the optimized sorting sequences determined by the control device, and
in which the packages are loaded into the transport units by the at least one robot in accordance with the optimized sorting sequences.

2. The method according to claim 1,
in which the packages are scanned in at least one preliminary transport sequence,
in which only individual packages are removed from the transport sequence and reintroduced to form the optimized transport sequence determined by the control device, and
in which the packages of the optimized transport sequence are sorted in a sorting device into at least two, preferably optimized, sorting sequences based on the at least one sorting parameter.

3. The method according to claim 1,
in which the packages of the transport sequence in at least one preliminary transport sequence are sorted in a sorting device into at least two preliminary sorting sequences based on the at least one sorting parameter, and
in which only individual packages are removed from the preliminary sorting sequences and reintroduced into the sorting sequences at a different position to form the optimized sorting sequences determined by the control device.

4. The method according to claim 1,
in which the loading state of the at least one transport unit for loading the packages is monitored during the loading of the packages by means of at least one, in particular optical, sensor, and
in which the control device determines the optimized sorting sequence on the basis of the loading state of at least one transport unit detected by the at least one sensor.

5. The method according to claim 1,
in which the at least one size parameter of the packages is scanned by means of a six-sided scanner, a line scanner, in particular an RGB line scanner, and/or a volume scanner.

6. The method according to claim 1,
in which at least two, in particular at least three, size parameters of each package are scanned and/or
in which the, in particular maximum, height, the, in particular maximum, length and the, in particular maximum, width of each package are scanned.

7. The method according to any claim 1,
in which the shape and/or the surface of the packages is scanned, preferably by means of a six-sided scanner, a line scanner, in particular an RGB line scanner, and/or a volume scanner, and
in which, preferably, the control device determines, based on the scanned shape and/or the surface of the packages, whether the shape is at least one predetermined special shape of the packages.

8. The method according to claim 7,
in which the packages with predetermined special shapes are removed from the, in particular preliminary, transport sequence and/or from the, in particular preliminary, sorting sequence, and
in which, preferably, the removed packages with special shapes are loaded, preferably manually, into at least one, in particular separate, transport unit.

9. The method according to claim 7,
in which electronic 3D models of the packages are generated by the control device from the scanned shape and/or the surface of the packages, and
in which the control device also determines, based on the electronic 3D models of the packages, space-saving, optimized sorting sequences to be loaded successively into the transport units.

10. The method according to claim 7,
in which article classes of the packages are inferred by the control device based on the scanned shape and/or the surface of the packages, and
in which the control device also determines space-saving, optimized sorting sequences to be loaded successively into the transport units based on the article classes of the packages.

11. The method according to claim 1,
in which the weight of certain packages, preferably of each package, is determined, and
in which the control device also determines space-saving, optimized sorting sequences to be loaded successively into the transport units based on the weight of the packages.

12. The method according to claim 1,
in which size dimensions and/or sorting parameters of at least individual packages are communicated to the control device before the transport unit is unloaded, and
in which, preferably, the communicated size dimensions and/or sorting parameters of the at least individual packages are compared with the scanned size measures and/or sorting parameters with at least individual packages.

13. The method according to claim 12,
in which the control device determines an optimized sorting sequence of at least individual packages based on the communicated size measures and/or sorting parameters of at least individual packages, in particular before the at least individual packages are unloaded, and
in which, preferably, the optimized sorting sequence of the packages is determined by the control device after the scanning of the packages, taking into account the optimized sorting sequence theoretically determined before the scanning of the packages on the basis of the communicated size measures and/or sorting parameters.

14. The method according to claim 1,
in which the packages are unloaded from transport units in the form of utility vehicle structures, preferably box bodies, in particular of a truck, trailer or semi-trailer and/or from transport units in form of non-self-propelled low-floor vehicles, in particular in the form of trolleys, lattice boxes or ULDs and/or
in which the packages are loaded into non-self-propelled low-floor vehicles, in particular in the form of trolleys, pallet cages or ULDs.

15. The method according to claim 1,
in which packaged piece goods, in particular piece goods each packaged with a cardboard box, are used as packages, and
where, preferably, the piece goods are parcels.
